(19) United States
(12) Patent Application Publication
(10) Pub. No.: US 2009/0309011 A1
(43) Pub. Date: Dec. 17, 2009

(54) Sensitivity Enhancement of Near-Field Probes using Metamaterials

(76) Inventors: Omar M. Ramahi, Waterloo (CA); Muhammed Said Boybay, Waterloo (CA)

Correspondence Address: Omar Ramahi, Dept. of Electrical and Computer Eng.,, 200 University Avenue West, Waterloo, ON, N2L 3G1, omitted

(21) Appl. No.: 12/484,742

(22) Filed: Jun. 15, 2009

Related U.S. Application Data
(60) Provisional application No. 61/061,865, filed on Jun. 16, 2008.

(51) Int. Cl. G01J 1/42

(52) U.S. Cl. 250/227.11

(57) ABSTRACT

A method and material for increasing the sensitivity of near-field probes used in detecting a wide variety of materials and objects such as biological anomalies in tissues, cracks on metallic surfaces, composition of material such as permittivity and permeability . . . etc., is disclosed. The present invention includes having a metamaterial in front of near-field probes that result in increased sensitivity. The metamaterial to be placed in the presence of the near-field probe has electrical characteristics that can be described as single negative or double negative media. Once the single negative or double negative medium is placed in the close proximity or between the material to be investigated and the near-field probe, the sensitivity of the near-field probe to variation in the detected object or material will be enhanced. This invention is useful when the near-field probe is insensitive enough not to detect small variation in the composition or geometry of the target.

### CROSS-REFERENCE TO RELATED APPLICATIONS

Not Applicable

### STATEMENT REGARDING FEDERALLY SPONSORED RESEARCH OR DEVELOPMENT

Not Applicable

### FIELD OF THE INVENTION

The present invention relates generally to devices which typically employ radio signals, microwaves or signals in the optical frequency regime, and in particular to devices typically referred to as probes that use transmitted and reflected signals to characterize the composition of material or to detect abnormalities or defects in materials or surfaces such as cracks in metallic surfaces, biological anomalies in tissues, changes in physical parameters of media, or detection of hidden subsurface objects such as landmines.

### BACKGROUND OF THE INVENTION

Microwave or radio near-field detection techniques using near-field probes can be used to detect the presence of biological anomalies as in the case of malignant tumors present in healthy tissue media. Also, it can be used to detect irregularities in metallic surfaces such as cracks in turbine blades or cracks in the surface of aircrafts covered by paint. Another application of near-field microwave or radio probes is the detection of landmines composed of either metallic or non-metallic material. Near-field probes are also used to determine the electrical properties such as the dielectric permittivity and magnetic permeability of different materials by mathematically manipulating the energy transmitted and reflected at the interface of the probe and die material under test. Furthermore, near-field probes can be used indirectly to detect physical non-electrical characteristics of the material, such as temperature, moisture and density, through direct or indirect calculation of the electrical properties of the material.

Near-field probes designate a class of electromagnetic devices that detect the presence of an object located or buried in an otherwise homogeneous medium, or that gauges the composition of the object with the help of mathematical algorithms. The primary advantage of near-field probes in comparison to far-field based detection devices such as radars, is the exploitation of changes in the near field of the probe. The near field is dominated by a type of electromagnetic energy that does not have propagating characteristics. This type of electromagnetic energy that is dominant in the vicinity of a near-field probe is referred to as evanescent waves in contrast to propagating waves which are dominant in regions far away from the probe.

In the two key application of near-field probes mentioned above, the first being the detection of anomalies and the second the characterization of material, the sensitivity of the probe which is defined to be the electronically measurable reaction of the probe with and without the presence of the detectable object, varies depending on the type of probe used. The electronically measurable reaction of the near-field probe is either tile phase of the reflection coefficient, the magnitude of the reflection coefficient, or both the phase and magnitude. Near-field probes vary by their geometrical shapes, electrical connection to the transmitting and receiving devices, and the type of excitation employed relating to the electromagnetic field distribution within the probe. However, in all near-field probes, two major challenges exist. The first challenge is the sensitivity of the probe when the distance between the probe and the material that is interrogated (either detection or characterization) increases due to some limiting factor. The second challenge is detecting sub-surface objects, such as biological anomalies within tissues or objects that are buried under the surface or within a different medium such as landmines. Both of these challenges present a serious bottleneck for near-field probes that puts a severe limitation on their use.

In addition to detecting the presence of an object within a homogeneous medium near-field probes are also used to determine the position of the target within the medium, specifically, the depth of the target.

Near-field probes are operated at one or more frequencies. The characterization or detection takes place by processing the reflected signal coming out of the probe. If the distance between the probe and the target or the interrogated material increases, then the sensitivity drops. Near-field probes can be comprised of resonating or non-resonating electromagnetic devices. Irrespective of the mode of operation (resonance, or non-resonance), the near-field probe reacts to change in the stored magnetic and electric energy within the space including and surrounding the probe.

Metamaterial refers to engineered composite media comprised of resonating or non-resonating structures. The net effective electrical parameters of the metamaterial, such as the permittivity, the permeability, or both, permittivity and permeability have negative values. Metamaterial can be either single negative meaning that one but not both of the permittivity and permeability is negative or can be double negative meaning that both permittivity and permeability are negative. Double negative media is also referred to as left-handed medium or negative index medium. Reference is made to U.S. Pat. No. 6,791,432 as an example of metamaterial design and specifications.

### SUMMARY OF THE INVENTION

The invention describes a new method and material for improving the sensitivity of near-field probes using metamaterials. The present invention has the advantage of increasing both the sensitivity and the resolution of near-field probes, which are two critical parameters of near-field probes. The metamaterial is employed by inserting it between a near-field probe and the sample under test, between the near-field probe and the material to be characterized, or can be included within the near-field probe design. By metamaterial, it is meant engineered material comprised of periodic or aperiodic inclusions, or periodic or aperiodic resonators. The metamaterial can be single-negative medium, meaning the net effective permittivity or permeability, but not both, is negative, or can be double-negative medium meaning the net effective permittivity and permeability are both negative.

Near-field probes generate a quasi-static or non-propagating evanescent field in the vicinity of the probe. The energy stored by this stationary field is related to the reactance of the probe. When the stored energy changes, the reactance experienced by the probe changes, and, consequently the reflection coefficient of the probe changes. The change in the reflection coefficient can be either change in phase, change in magnitude, or change in both. The change in the reflection coefficient is an indication of a change in the material composition in the vicinity of the probe, an indication of a change in the geometry of the objects near the probe, or an indication of change in the location of the object.

The sensitivity of a near field probe for a target is defined by the change in the reactance of the probe caused by the presence of the target. The reactance of the probe is proportional to the difference between the magnetic (H) field energy and electric (E) field energy stored by the evanescent field generated by the probe. Therefore the sensitivity of tie probe is given as

$$Sensitivity = \vert 1 - \frac{{( {U}_{m} - {U}_{e} )}_{with target}}{{( {U}_{m} - {U}_{e} )}_{without target}} \vert \qquad ( 1 )$$

where Uₘ is the total magnetic field energy stored around the probe and Uₑ is the total electric field energy stored around the probe. For dispersive materials Uₑ and Uₘ can be calculated by

$$\begin{matrix}{U}_{e} = {\int }_{V} \frac{1}{2} \frac{\partial ( ω ɛ ( ω ) )}{\partial ω} {\vert E \vert}^{2} d v & ( 2 ) \\ {U}_{m} = {\int }_{V}^{ } \frac{1}{2} \frac{\partial ( ω μ ( ω ) )}{\partial ω} {\vert H \vert}^{2} d v & ( 3 )\end{matrix}$$

where ω is the angular frequency. ε(ω) and μ(ω) are frequency dependent permittivity and permeability of the medium, respectively, suitably characterizing single or double negative media. E and H are the electric field and magnetic field intensities. The integrations are defined over the volume in which the magnetic and electric fields are non zero, or more generally, the volume in the vicinity of the probe encompassing the medium and target under test.

A probe with a higher sensitivity practically means a higher accuracy for material characterization schemes, or the ability to detect smaller or deeper objects for detection schemes. Material characterization refers to the extraction of electrical and magnetic properties of materials or investigation of physical or chemical properties of materials using the electrical and magnetic properties. Object detection refers to detecting any geometrical change in the vicinity of the probe which includes detecting objects placed within a medium or detecting any change in the surface topology of objects, etc.

The term negative materials refers to the materials possessing negative permittivity and negative permeability (double negative materials), or materials possessing negative permittivity and positive permeability (ε-negative materials), or materials possessing positive permittivity and negative permeability (μ-negative material). Negative materials are available naturally in the optical frequencies, such as silver, or can be manufactured artificially to have such characteristics in other frequencies.

According to Boybay and Ramahi, Near-Field Probes Using Double and Single Negative Media, Physical Review E, Vol. 79, p. 016602, January 2009, the sensitivity of near field probes increases when a negative material slab is used in the probe design. The sensitivity enhancement of a single evanescent plane wave component is analyzed when a negative material slab is placed between the probe and the sample under test. An evanescent plane wave is defined by the following parameters:
1. Mode of the wave: The mode is defined according to the polarization of die E field and H field components. If the wave has no E field component that is perpendicular to the surface of the negative material, it is called transverse electric (TE) mode. Similarly, if the wave has no H field component perpendicular to the surface of the negative material, it is transverse magnetic (TM) mode.
2. Parallel k component: The wave vector of the field is represented by k. The parallel k component refers to the component of the wave vector parallel to the surface of the negative material slab. This parameter is expected to be larger than k₀, the wave number of the medium, in order for the wave to be evanescent.

The field generated by a near-field probe is composed of plane waves that arc defined by the two parameters defined above, namely, the mode of the wave and tie parallel k component. Therefore the spectrum of a near-field probe is defined as the magnitudes of the evanescent plane waves present in the field generated by the probe. An evanescent plane wave with a larger parallel k component decays faster compared to a wave with smaller parallel k component.

Materials with negative permittivity amplify TM mode evanescent fields. Materials with negative permeability amplify TE mode evanescent fields. Materials with negative permittivity and negative permeability simultaneously amplify both TE and TM mode evanescent fields. The amplification definition employed here is consistent with Pendry, Negative refraction makes a perfect lens, Physical Review Letters, Vol. 85, p. 3966, October 2000. Therefore the sensitivity improvements arc realizable for these configurations.

Double negative materials if lossless, improve the sensitivity of the entire evanescent field spectrum. Therefore independent of the shape of the near field probe, a double negative material layer improves the sensitivity of any near field probe. If double negative material in not lossless, however, the sensitivity improvement is deteriorated. The deterioration is more effective for the evanescent plane waves with higher parallel k components.

ε-negative or μ-negative materials (single negative materials) improve the sensitivity of a finite evanescent plane wave spectrum. If the single negative material is lossless, at specific parallel k components, defined as k_{c}, the sensitivity improvement experiences a singularity meaning that the sensitivity approaches infinity. k_{c} is dependent on the thickness of the single negative material layer, the distance between the single negative material layer and the sample under test, and is also dependent on the permittivity and permeability of the single negative metamaterial. In order to obtain sensitivity improvement, the parallel k component of the plane wave must be smaller than k_{c} or preferably equal to k_{c}. Therefore single negative metamaterials are more efficient for sensitivity improvement compared to double negative materials if the near-field probe to be improved has an evanescent spectrum concentrated around k_{c}.

### BRIEF DESCRIPTION OF THE DRAWINGS

FIG. 1 is a view of multilayer structure used to analyze the sensitivity improvement of a generic near-field probe.

FIG. 2 is a chart showing the sensitivity improvement obtained by double negative layers with different thicknesses.

FIG. 3 is a chart showing the sensitivity improvement obtained by single negative layers with different thicknesses.

FIG. 4 is a view of an open-ended waveguide, considered here as a near-field probe, with metamaterial layer positioned between the probe and the medium to be detected or characterized.

FIG. 5 is a chart showing the variability and the improvement of the sensitivity of open ended waveguide near-field probe shown in FIG. 1 as a function of standoff distance d and negative material thickness t. The improvement is gauged by the change in the phase of the reflection coefficient.

FIG. 6a is an image of a 1 mm sided cubic crack on an aluminum surface generated by an open-ended waveguide enhanced with an single negative metamaterial layer.

FIG. 6b is an image of a 1 mm sided cubic crack on an aluminum surface generated by an open-ended waveguide.

FIG. 7 is a view of a metamaterial loaded open-ended waveguide near-field probe enhanced by loading negative material slab within the probe

FIG. 8 is a chart showing the variability and the improvement of the sensitivity of loaded open ended waveguide probe shown in FIG. 3 as a function of standoff distance d and negative material thickness t. The improvement is gauged by the change in the phase of the reflection coefficient.

### DETAILED DESCRIPTION OF THE INVENTION

The interaction between a near-field probe and target is modeled by using multi-layer media. The energy coming from the near-field probe is represented as evanescent plane waves since all time-harmonic fields can be expressed as a superposition of plane waves. Therefore the overall response of a near-field probe is a combination of die responses of plane waves present in its spectrum.

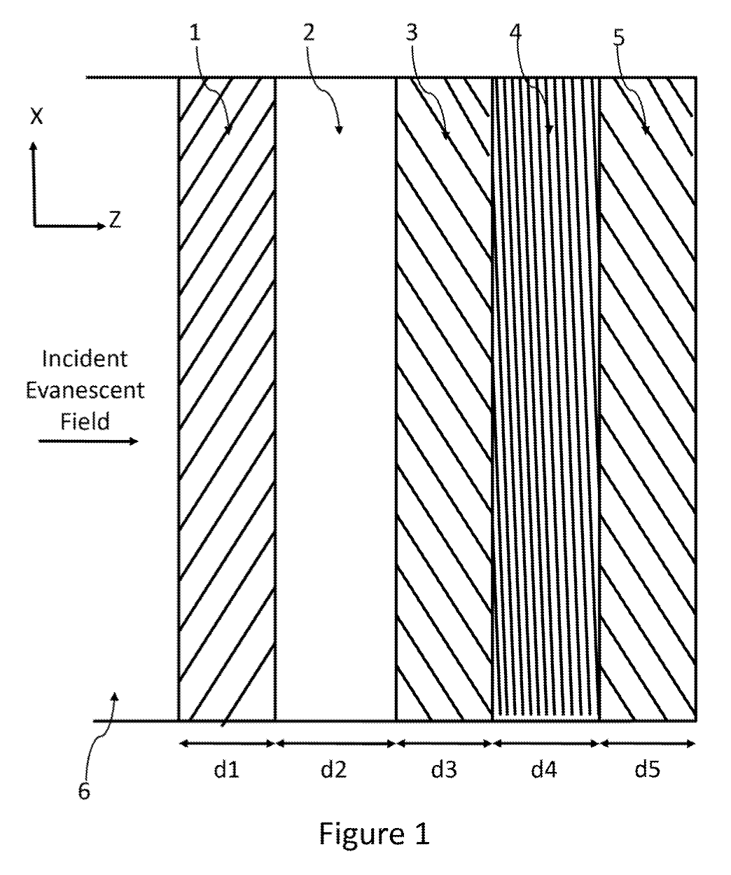

FIG. 1 shows the multilayer structure used for analyzing the effect of negative materials on the sensitivity of a single evanescent plane wave. The following configurations are to demonstrate the sensitivity enhancement capabilities of negative materials and the invention is not limited to these configurations. The target 4 is represented by a layer with a permittivity different than the surrounding medium, referred as the target medium. Therefore the target 4 is assumed to be buried within the target medium 3. The structure is composed of 6 regions corresponding to the negative metamaterial layer 1, the space between the negative metamaterial layer and the target medium 2, the target medium 3, the target 4 and the half space 5 which is composed of the same material as the target medium 3. The incident evanescent field is sent from a half space region 6 which is assumed to be vacuum. The space between the negative material layer and the target medium 2 is assumed to be vacuum.

Assuming a time-harmonic incident field in the left-hand half space in the form of

E=ye^{i(k}^{ₓ}^{x+k}^{_{z}}^{z}) (4)

the field distribution is found by solving the multilayer scattering problem with boundary conditions, and the sensitivity is calculated using equation 1. kₓ is the parallel k component and is larger than the wave numbers of the all materials available in the stricture. Therefore die wave is evanescent in all six regions presented in FIG. 1.

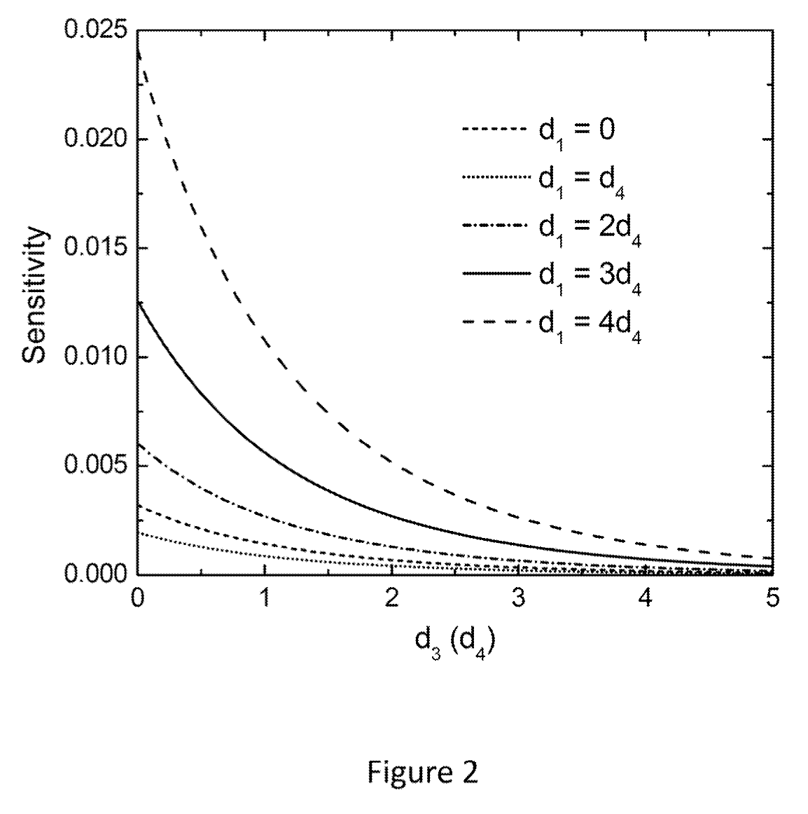

FIG. 2 shows the sensitivity as a function of target depth d₃ for different negative material thicknesses d₁. The negative material is a double negative material with ε=−1 and μ=−1. As an example, we consider a target medium permittivity of 2 and the permittivity of the target as 6. Both the target medium and the target are lossless and non-magnetic. d₂ is assumed to be zero. All the thicknesses are defined in terms of the thickness of the target d₄ which is equal to λ/75 where λ is the free-space wavelength of the operation frequency. The parallel k component is assumed to be equal to 1.5 kₘₐₓ. The wavenumber of the material with the largest εμ product is defined as the kₘₐₓ. FIG. 2 shows that the thicker the double negative material layer, the higher the sensitivity, however, there is a minimum double negative layer thickness required to achieve a sensitivity improvement. For example, a double negative layer with a thickness of d₄ does not improve the sensitivity. In fact, it turns out that a double negative thickness greater than 1.4 d₄ is needed for this particular configuration.

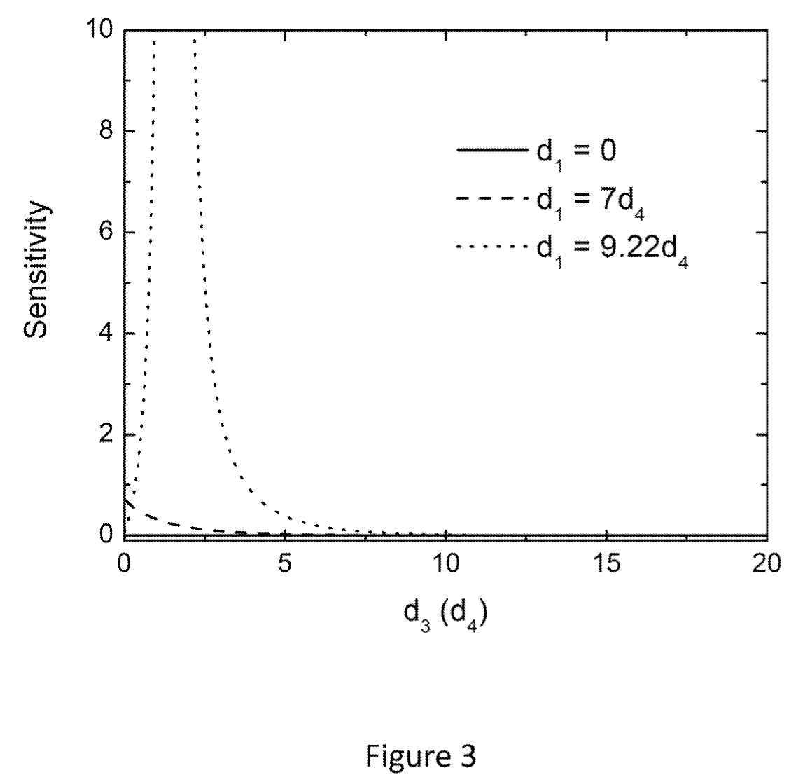

In FIG. 3, the sensitivity as a function of target depth d₃ is plotted for different single negative layer thicknesses. The incident field is a TE wave with kₓ=1.5 kₘₐₓ. The single negative material has a permittivity of 1 and a permeability of −1. The permittivity of the target is equal to 6 and the permittivity of the target medium is 2. For this configuration, a singularity is observed with a single negative layer of 9.22 d₄ thickness and a target depth of 1.5 d₄. When the single negative layer is thinner than the singularity condition, the sensitivity improvement is similar to the double negative layer case. If the lens is thicker, the sensitivity improvement is reduced and increasing the thickness further eventually results in lower sensitivity. The single negative layer thickness at which the singularity is observed shrinks as the parallel k component kₓ increases. While both single and double negative metamaterials improve the sensitivity, the single negative metamaterials could have advantage over the double negative metamaterials due to fabrication considerations. The drawbacks of the single negative metamaterials arc the limitations over the evanescent spectrum, slab thickness and its selectivity vis-à-vis TE and TM waves. On the other hand the single negative metamaterial, due to the transmission singularity, has the potential for strong substantial improvement in the sensitivity. Note that a similar structure with an ε-negative material can be used to improve the sensitivity of a TM mode evanescent wave.

The configurations presented above are to demonstrate the sensitivity enhancement capabilities of negative metamaterials and the invention is not limited to these configurations. By configuration it is meant the type of the evanescent field mode such as TE or TM, the number of layers that define the target medium, the target and the surrounding space parameters.

### Application to Open-Ended Waveguides:

The present invention will be described for two sample applications. The invention is not limited to these applications. Both the probe type and the detection scheme can be replaced by any near-field probe configuration and other applications.

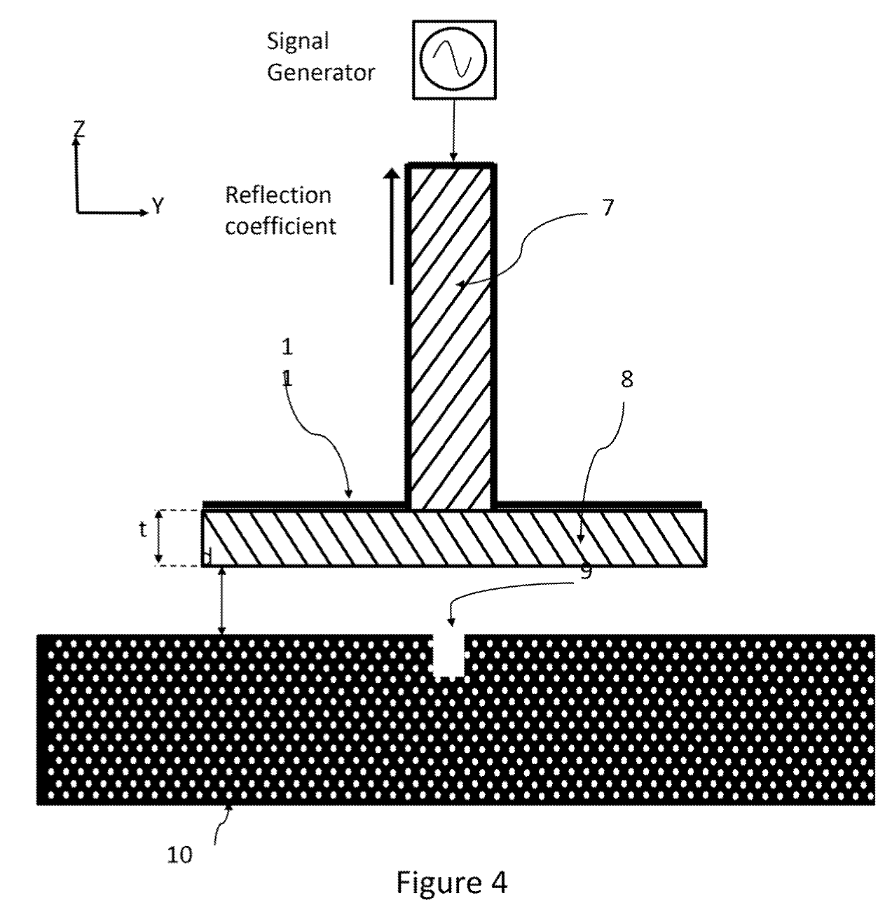

FIG. 4 describes an example of using negative material to improve the sensitivity of an open ended waveguide considered here as the near-field probe 7. According to M. T. Ghasr, S. Kharkovsky, R, Zoughi and R. Austin IEEE Trans. Instrum. Meas., Volume 54. Pages 1497-1504, the open-ended waveguide is used for detecting cracks on aluminum bodies. A μ-negative material layer 8 is placed between the open ended waveguide and the sample under test 10. As an example, the operation frequency is selected to be 30 GHz, the waveguide is selected to be a rectangular waveguide with a cross section of 7.11 min by 3.56 mm with flanges at its opening 11. The sample under test is an aluminum plate with a 1 mm by 1 mm cubic crack 9 at the center.

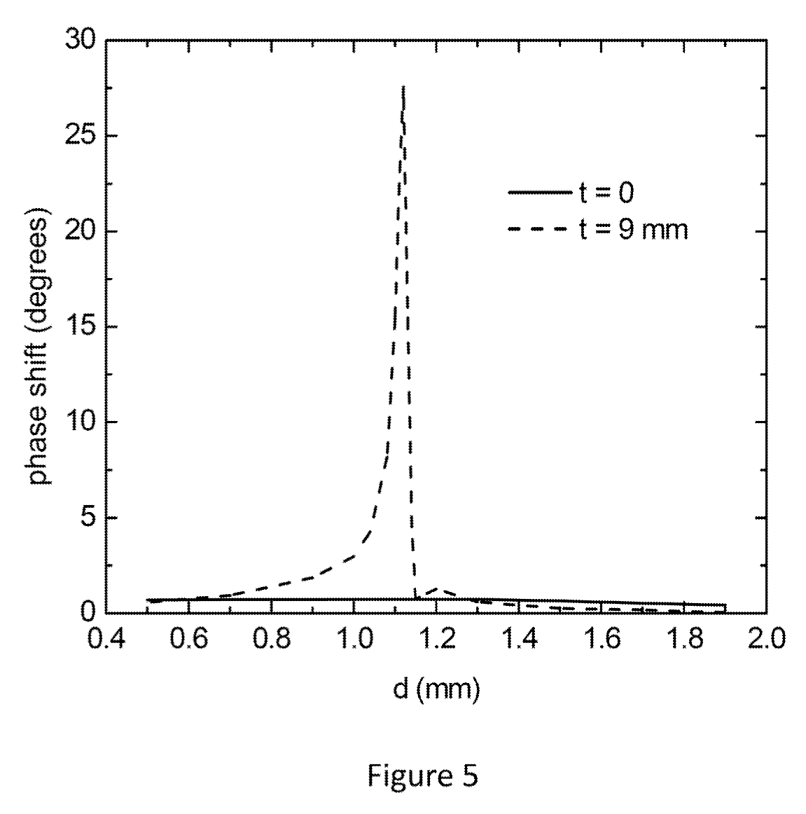

The phase of the reflection coefficient changes when there is a crack around the opening of the waveguide. A higher difference between the reflection phase with and without the crack means a higher sensitivity. FIG. 5 shows the change in the reflection coefficient for two cases as a function of the standoff distance, d. When appropriate μ-negative material thickness, t, and standoff distance, d, arc used, the sensitivity of the open ended waveguide probe is increased by more than 30 times.

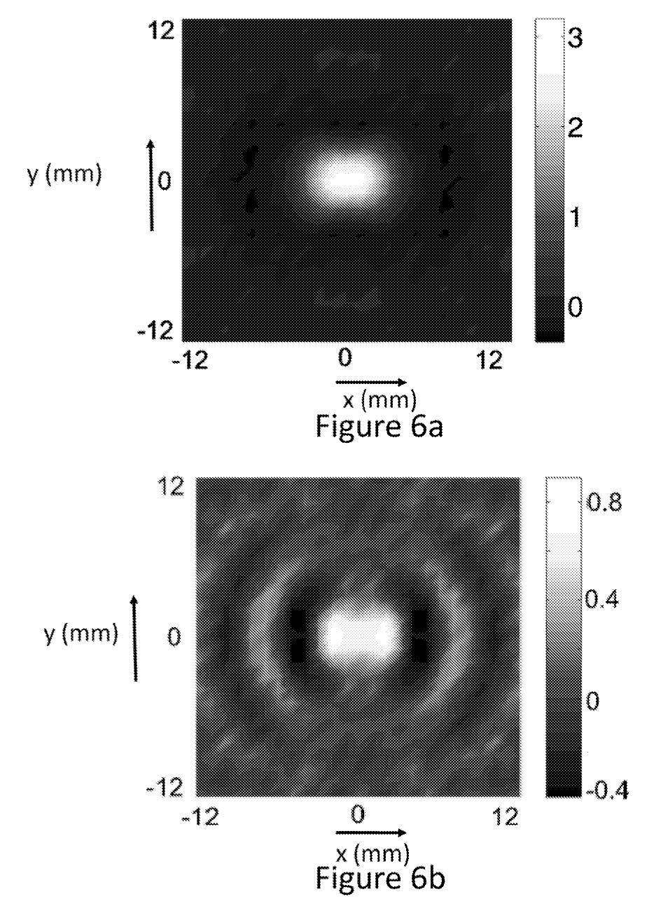

FIG. 6a shows the image generated by an open-ended waveguide enhanced by a μ-negative layer. t is equal to 0.8 mm and d is equal to 1 mm. FIG. 6b shows the image generated by an open-ended waveguide without using a μ-negative layer. t is equal to 0 mm and d is equal to 1 mm. The scale shown in the figures are in degrees. The images are generated by scanning the probes over the aluminum plate and by recording the change in the reflection coefficient. The probe enhanced by the negative layer both gives a higher sensitivity (higher peak in the phase shift) and a more clear image, indicating a higher resolution.

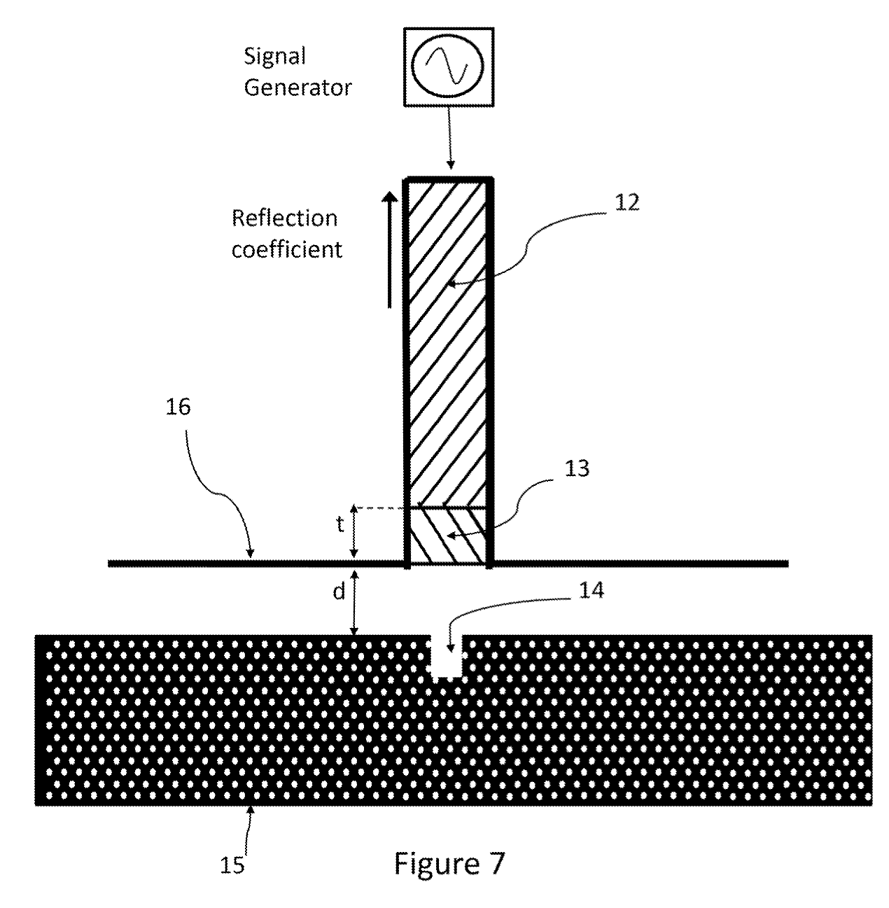

FIG. 7 describes another sample application as an example of employing the negative material within the near field probe design. The near field probe is an open ended waveguide partially loaded by a high dielectric material 12 and partially loaded by a negative material 13. For this example, the operation frequency is 10 GHz, the cross section of the rectangular waveguide is 7.11 mm by 3.56 mm with flanges at its opening 16, the dielectric filling has a permittivity of 8.8 and the negative material is a μ-negative material. The dielectric region of the waveguide supports propagating waves. The μ-negative region of the waveguide is in the cutoff, which results in an evanescent field with in this region. The sample under test 15 is an aluminum plate with a 1.5 mm by 1.5 mm cubic crack 14 at the center.

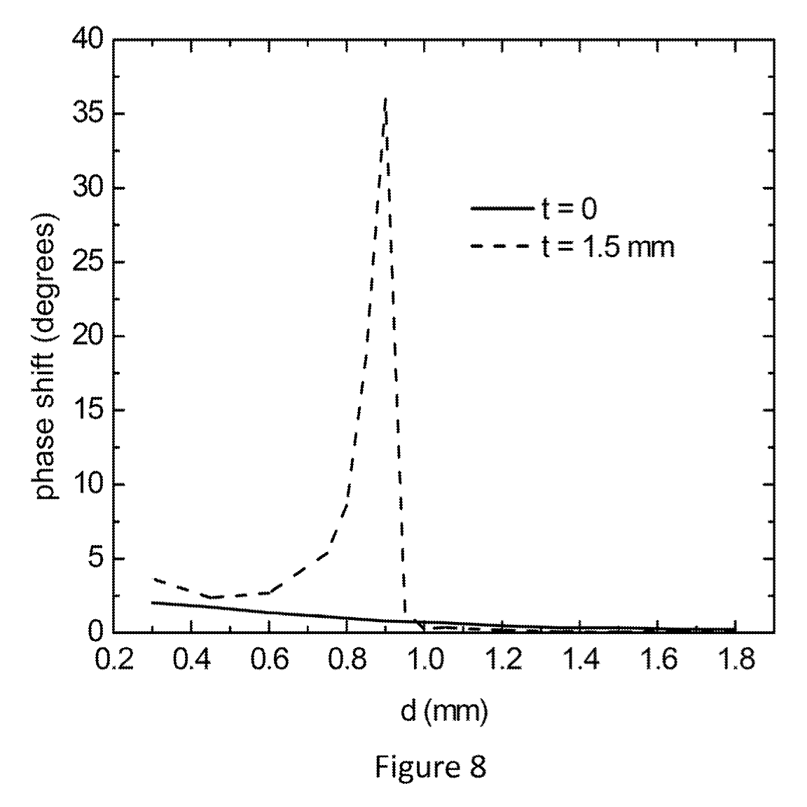

The phase of the reflection coefficient changes when there is a crack around the opening of the waveguide. A higher difference between the reflection phase with and without the crack means a higher sensitivity. FIG. 8 shows how the negative material region thickness improves the phase shift due to the crack.

Having thus described the invention what is claimed is:

1. A method to increase the sensitivity of near-field probes comprising metamaterials

2. The method of claim 1 wherein the metamaterial is μ-negative.

3. The method of claim 1 wherein the metamaterial is ε-negative.

4. The method of claim 1 wherein the metamaterial is μ-negative and ε-negative simultaneously.

5. The method of claim 1 wherein the metamaterial is made of electrically-small resonators such as split ring resonators or any other resonating structure sufficient to generate net effective negative permittivity or permeability.

6. The method of claim 1 wherein metamaterial means composite material that displays properties beyond those found in naturally occurring materials.

7. The method of claim 1 wherein near-field probes include electromagnetic devices that detect changes in material composition or changes in material shape and location.

8. The method of claim 1 wherein the near-field probes is a resonating or non-resonating device.

9. The method of claim 1 wherein the near-field probe is operating at any frequency within the electromagnetic spectrum.

10. The method of claim 1 wherein the near-field probe is an electromagnetic transmitter operating based on the principle of evanescent waves and the change in the magnetic and electric energy within the medium surrounding the probe.

11. The method of claim 1 wherein the near-field probe is an open-ended waveguide or open-ended loaded waveguide.

12. The method of claim 1 wherein the metamaterial is confined to a small area in the proximity of the probe or extending to an area much larger than the size of the probe.

13. The method of claim 1 wherein the sensitivity means wider variation in the phase of die reflected signal coming out of the near-field probe, wider variation of the magnitude of the reflected signal coming out of the near-field probe, or wider variation of the phase and magnitude coming out of the near-field probe.

14. The method of claim 1 wherein increasing the sensitivity means higher resolution when detecting surface or sub-surface anomalies or objects present in homogeneous or inhomogeneous media.
